(19) United States
(12) Patent Application Publication
(10) Pub. No.: US 2010/0033490 A1
(43) Pub. Date: Feb. 11, 2010

(54) PORTABLE DISPLAY DEVICES AND PROGRAMS

(75) Inventor: Hiroki SUGAMATA, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi, Aichi-ken (JP)

(21) Appl. No.: 12/538,102

(22) Filed: Aug. 7, 2009

(30) Foreign Application Priority Data
Aug. 7, 2008 (JP) 2008-204436

(51) Int. Cl. G06T 1/60

(52) U.S. Cl. 345/530

(57) ABSTRACT

A portable display device transitions between a first state and a second state. The portable display device includes a display portion that displays information when the portable display device is in the first and second state, and a power source for supplying power when the portable display device is in the first state, and supplying less power when the portable display device is in the second state than in the first state. The portable display device also includes a controller that drives the display portion to display information in the display portion, an operation device that executes at least one command in response to receipt of at least one operation, and a storage portion that stores information to be displayed in the display portion when the portable display device is in the second state. The controller displays the information stored in the storage portion, when the portable display device is in the second state.

### CROSS REFERENCE TO RELATED APPLICATION

The present application claims priority from Japanese Patent Application No. 2008-204436, which was filed on Aug. 7, 2008, the disclosure of which is incorporated herein by reference in its entirety.

### BACKGROUND OF THE INVENTION

1. Field of the Invention

The invention relates to portable display devices and programs, and more particularly to portable display devices and programs for maintaining a display image or information in the portable display devices even when power from a power source is turned off.

2. Description of Related Art

A known portable display device, e.g., electronic paper, includes a non-volatile display device configured to maintain display information, e.g., an image, even when power supply from a power source is turned off. One such portable display device, e.g., the portable display device described in Japanese Laid-Open Patent Publication No. 2007-187927, is configured to maintain only the information which was displayed in the non-volatile display device immediately before power is turned off. Therefore, a user may view the last information viewed after the device is turned off. Another known portable display device is configured to make a notification display for security reasons in which information that was displayed in a non-volatile display device immediately before power is turned off is erased and textual information such as “Power off” is displayed in the non-volatile display device.

The above-described devices only displays the information, which was displayed immediately before power is turned off, or make the notification display, in a power-off state. Therefore, information that a user desires may not be displayed in the non-volatile display device in a power-off state, which may be inconvenient for users.

### SUMMARY OF THE INVENTION

Therefore, a need has arisen for portable display devices which overcome these and other shortcomings of the related art. A technical advantage of the invention is that a portable display device and a program for displaying information that a user desires in a non-volatile display device in a power-off state.

In an embodiment of the invention, a portable display device configured to transition between a first state and a second state comprises a display portion configured to display information when the portable display device is in the first state and when the portable display device is in the second state, a power source configured to supply power when the portable display device is in the first state, and to supply less power when the portable display device is in the second state than when the portable display device is in the first state, a controller configured to drive the display portion to display information in the display portion, an operation device configured to execute at least one command in response to receipt of at least one operation, and a storage portion configured to store information to be displayed in the display portion when the portable display device is in the second state. The controller is configured to display, in the display portion, the information stored in the storage portion, when the portable display device is in the second state.

In another embodiment of the invention, a computer program product has computer readable instructions stored thereon, which, when executed by a processor of a portable display device, configures the processor to perform the steps of driving a display portion to display information when the portable display device is in a first state, the first state corresponding to the portable display device receiving a power supply from a power source, receiving at least one operation command from at least one operation device, storing information in an information storage portion, to be displayed in the display portion when the portable display device is in a second state, the second state corresponding to the portable display device receiving less power from the power source than when the portable display device is in the first state, transitioning the portable display device from the first state to the second state, and displaying the information stored in the information storage portion, when the portable display device is in the second state.

Other objects, features, and advantages of embodiments of the present invention will be apparent to persons of ordinary skill in the art from the following description of preferred embodiments with reference to the accompanying drawings.

### BRIEF DESCRIPTION OF THE DRAWINGS

For a more complete understanding of the present invention, the needs satisfied thereby, and the objects, features, and advantages thereof, reference now is made to the following description taken in connection with the accompanying drawings.

FIG. 1 is a front view of a portable display device, according to an embodiment of the invention.

FIG. 2 is a schematic showing an electrical configuration of the portable display device and an external device, according to an embodiment of the invention.

FIGS. 3A and 3B are schematics showing power-off display tables, according to an embodiment of the invention.

FIGS. 4A-4F are schematics showing an electrophoretic display device of the portable display device, according to an embodiment of the invention.

FIG. 5 is a flowchart showing a process performed in the portable display device, according to an embodiment of the invention.

FIG. 6 is a flowchart showing a process performed in the portable display device, according to an embodiment of the invention.

FIG. 7 is a flowchart showing a process performed in the portable display device, according to an embodiment of the invention.

FIG. 8 is a flowchart showing operations performed in the external device, according to an embodiment of the invention.

FIGS. 9A-9C are schematics showing power-off display tables according to another embodiment of the invention.

### DETAILED DESCRIPTION OF EMBODIMENTS OF THE INVENTION

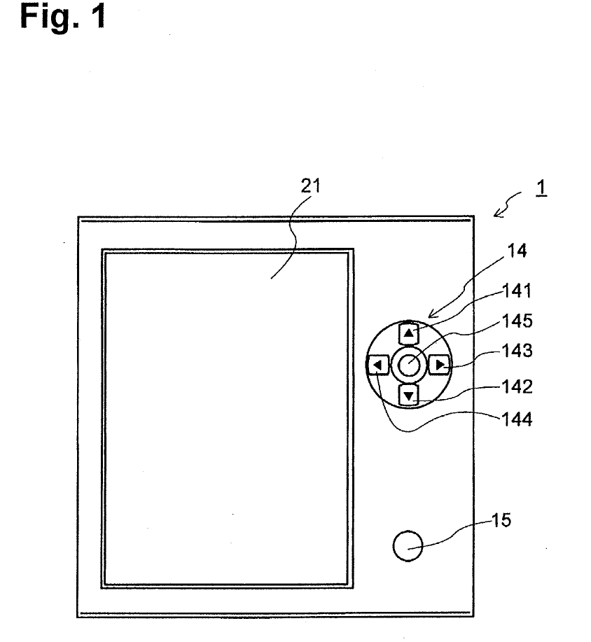

Embodiments of the present invention and their features and technical advantages may be understood by referring to FIGS. 1-9C, like numerals being used for like corresponding portions in the various drawings.

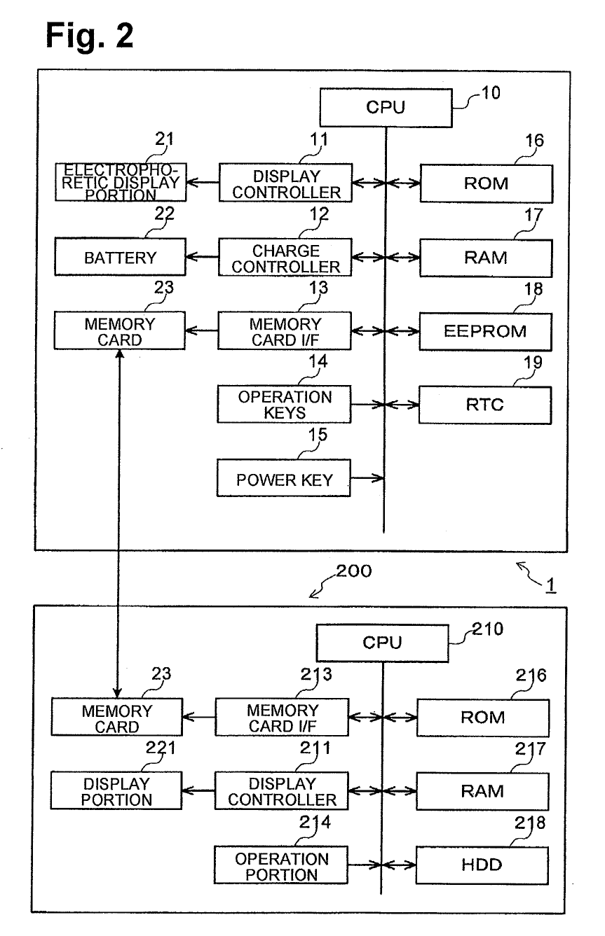

Referring to FIG. 1, a portable display device 1 according to an embodiment of the present invention may have a substantially rectangular parallelepipedonal shape. Portable display device 1 may comprise an electrophoretic display portion 21. Electrophoretic display portion 21 may be disposed on a front surface of portable display device 1. A right side of portable display device 1 in FIG. 1 may comprise a card slot (not shown) into which a memory card 23 in FIG. 2 may be inserted. Portable display device 1 may display contents, e.g., contents stored in memory card 23, on electrophoretic display portion 21. In this embodiment, information, e.g., at least one of a text, a freeze-frame image, and a moving image, may be displayed based on the contents. Content data may comprise at least one piece of data for displaying a text, a freeze-frame image, and a moving image.

Portable display device 1 in FIG. 1 may comprise operation keys 14 that may be operated by a user. In an embodiment of the invention, as shown in FIG. 1, operation keys 14 may be positioned to the right of and substantially adjacent to electrophoretic display portion 21. Operation keys 14 may comprise at least an enter key 145, and an up arrow key 141, a down arrow key 142, a right arrow key 143 and a left arrow key 144. Keys 141, 142, 143, and 144 may be disposed on the upper, lower, right and left side of enter key 145, respectively. For example, up arrow key 141 and down arrow key 142 may be used to select a content in a screen listing contents or a menu screen. Right arrow key 143 and left arrow key 144 may be used to turn pages of a content displayed in electrophoretic display portion 21. A content stored in memory card 23 may be displayed in display portion 21 or instructions for various settings may be provided, with the operations of operation keys 14 according to the information displayed in electrophoretic display portion 21. Moreover, a power key 15 may be disposed on a portion of device 1 below operation keys 14 in FIG. 1. Power key 15 may provide instructions for turning power on or off.

Referring to FIG. 2, device 1 may comprise a central processing unit (“CPU”) 10, a display controller 11, a charge controller 12, a memory card interface (“I/F”) 13, operation keys 14, power key 15, a read-only memory (“ROM”) 16, a random access memory (“RAM”) 17, an electrically erasable programmable read-only memory (“EEPROM”) 18, and a real time clock (“RTC”) 19.

CPU 10 may perform control of device 1. CPU 10 may drive display portion 21 to display information therein. ROM 16 may store various data and programs for operating device 1. RAM 17 may temporarily store various data. EEPROM 18 may be a non-volatile memory and store various data, such as a power-off display table which will be discussed in more detail herein. RTC 19 may measure time. Display controller 11 may control a display in the display portion 21. Memory card I/F 13 may control reading/writing of data from/into memory card 23. Device 1 may be driven by power supplied from a battery 22 when power is not supplied from an external power source (not shown). Battery 22 may be a rechargeable type of battery. There may be two power supply routes from a power source, e.g., battery 22 or the external power source, one for CPU 10 and the other for peripheral devices, such as ROM 16, RAM 17, EEPROM 18, and display controller 11. Charge controller 12 may control a delivery of charge to battery 22 from the external power source.

Device 1 may be configured to transition between a first state, e.g., a power-on state, in which power is supplied to device 1 and the components which device 1 comprises, and a second state, e.g., a power-off state, in which power is not supplied to device 1 and the components which device 1 comprises. These states will be discussed in more detail herein.

When device 1 is in a power-off state, pressing power key 15 or any of operation keys 14, may cause an instruction to turn power on to be provided. Upon receipt of this instruction, CPU 10 may transition to a normal operation mode, and the peripheral devices may receive power supplied from the power source. Thus, device 1 may be brought into an operational state. When device 1 is in a power-on state, pressing power key 15 may cause an instruction to turn power off to be provided. Upon receipt of this instruction, Power supply to the peripheral devices may be suspended or stopped, and CPU 10 may transition to a power-saving mode in which CPU 10 consumes less power than in its normal operation mode. When device 1 is in a power-on state, and a user does not operate any operation keys 14 for a predetermined period of time, e.g., a power-off setting time, device 1 may be determined to be in a non-operating state. In an embodiment of the invention, power key 15 may be disposed in device 1. In another embodiment of the invention, power key 15 may be omitted, and any key may function as power key 15 by pressing and holding the key for a predetermined amount of time.

In an embodiment of the invention, when device 1 is in a power-off state, any one, or a specific combination outlined below, of the following sets of conditions may be true:

(a) Power supply to CPU 10 may be suspended or stopped;

(b) Power supply to at least one of the peripheral devices (e.g., RAM 17, controllers such as display controller 11, display portion 21) may be suspended or stopped;

(c) At least one of the peripheral devices may be placed in a power-saving mode in which power consumption may be more saved than in a normal operation mode of the at least one of the peripheral devices; and

(d) CPU 10 may be placed in a power-saving mode in which its power consumption may be more saved than its normal operation mode.

Specifically, any one of the previously listed conditions may be true when device 1 is in a power off state. Moreover, any of the following combinations of conditions may be true when device 1 is in a power-off state:

(1) any combination of the previously-listed conditions (a)-(c); and

(2) any combination of the previously conditions (b)-(d).

Device 1 may transition to the power-off when one or more of the following events occur: (1) when power key 15 is pressed; (2) when any of operation keys 14 are not pressed for a predetermined period of time; (3) when the remaining amount of battery 22 becomes smaller than a predetermined amount; and (4) when power is not supplied from battery 22 because battery 22 runs our or when battery 22 is not mounted on device 1.

Display portion 21 may be a non-volatile display device and may maintain display information when power supply is suspended from the power source to display portion 21. Thus, the display information may be viewed in display portion 21 even while power is saved, e.g., in a power-off state.

Device 1 may be configured to read data from, or write data into, an external device 200, e.g., via memory card 23. External device 200 may be configured to provide device 1 with data of a content body, e.g., a document, and data regarding the information to be displayed in display portion 21, in association with the content, when the device 1 power is turned off. The information to be displayed in display portion 21 when the device 1 power is off may be hereinafter simply referred to as “power-off display information.”

As shown in FIG. 2, device 200 may comprise a central processing unit (“CPU”) 210, a display controller 211, a memory card interface (“I/F”) 213, an operation portion 214, a read-only memory (“ROM”) 216, a random access memory (“RAM”) 217, a hard disk drive (“HDD”) 218, and a display portion 221. CPU 210 may perform control of device 200. ROM 16 may store various data and programs for operating device 200. RAM 217 may temporarily store various data. HDD 218 may be a non-volatile storage medium configured to store various data for device 200. Display controller 211 may control display portion 221 to display information therein. Memory card I/F 213 may control reading data from and writing data into a memory device, e.g., memory card 23.

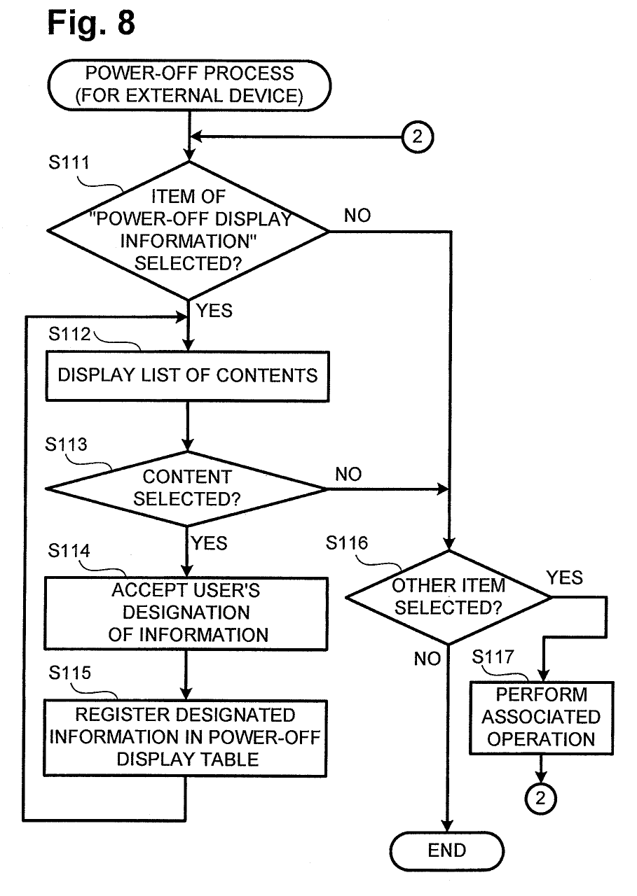

Device 200 may provide device 1 with data associated with a content, via memory card 23. Device 200 also may provide device 1 with power-off display information, which may be set in association with a content. Device 200 further may provide device 1 with settings for the power-off display information. A method for performing such a process, according to an embodiment of the invention, is shown in FIG. 8, and will be discussed in more detail herein.

Display portion 21 may comprise an electrophoretic display panel (not shown), a gate driver (not shown) configured to output a gate line signal to respective gate lines of the electrophoretic display panel, and a source driver (not shown) configured to output a source signal to respective source lines of the electrophoretic display panel. Display controller 11 may be configured to control the gate driver and the source driver of display portion 21. Display controller 11 may rewrite information displayed in display portion 21, based on a rewriting instruction received from CPU 10. The electrophoretic display panel may be an active matrix type. The electrophoretic display panel may comprise a transparent substrate positioned on a front side, e.g., a viewing side, and a rear substrate positioned opposite to the transparent substrate.

Electrophoretic display elements may be positioned between the transparent substrate and the rear substrate. The active matrix type-display panel may be configured to rewrite information displayed in display portion 21 by applying voltage to a common electrode positioned on the transparent substrate and a pixel electrode positioned on the rear substrate for each pixel. As the gate driver and the source driver receive the rewriting instruction from display controller 11, the date driver and the source driver may be configured to output a gate signal and a source signal corresponding to the information to be rewritten, to the gate lines and the source lines, respectively. A voltage for controlling the electrophoretic display elements may be applied to each pixel electrode to rewrite information displayed in the display panel.

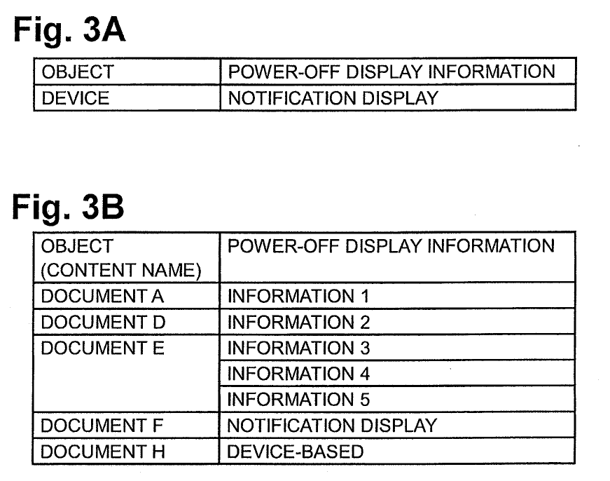

FIGS. 3A and 3B refer to a power-off display table used to determine power-off display information, according to an embodiment of the invention. The power-off display table may comprise a power-off display table for device 1, as shown in FIG. 3A, and a power-off display table for contents, as shown in FIG. 3B. The power-off display table for device 1 may store settings of power-off display information for device 1. The power-off display table for contents may store settings of power-off display information for each of contents. The power-off display table may be stored in EEPROM 18 or memory card 23. In an embodiment of the invention, the power-off display table for device 1 may be stored in EEPROM 18, and the power-off display table for contents may be stored in memory card 23.

Operation keys 14 or operation portion 214 of external device 200 may be operated to update, add, or change the settings of the power-off display information in the power-off display table. The power-off display table may store settings of the power-off display information corresponding to an object for which power-off display information is set.

Settings of power-off display information may comprise information e.g., an image such as information 1-5 in FIG. 3B, a notification display, and a device-based setting. With the notification display setting, information that was displayed in display portion 21 immediately before power is turned off, may be erased and textual information, e.g., “Power off”, may be displayed in display portion 21 when device 1 is in a power-off state. When using the device-based setting, the power-off display information may be determined based on the settings in the power-off display table for device 1. The device-based setting may be set only in the power-off display table for contents. The device-based setting may be set to a content as a default setting. For example, the device-based setting may be set to document H in the power-off display table for contents, as shown in FIG. 3B. When this setting is used, then when power is turned off while document H is displayed in display portion 21, the power-off table for device 1, as shown in FIG. 3A, may be referred to and the notification display may appear in display portion 21 accordingly.

More than one, e.g., a plurality of, pieces of power-off display information may be set to correspond to a single object in the power-off display table. For example, as shown in FIG. 3B, information 3, 4 and 5 may be set to document E in the power-off display table for contents. EEPROM 18, memory card 23, or both, may store the power-off display table, as described above. EEPROM 18 and memory card 23 may also store contents data, as well as data corresponding to images that may be set as power-off display information, e.g., information 1-5, as shown in FIG. 3B.

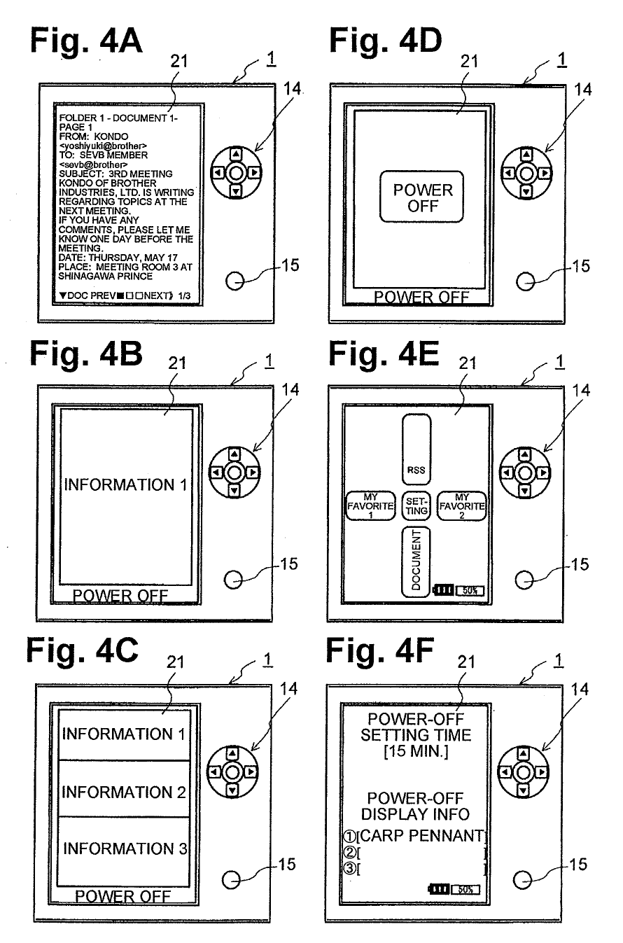

As shown in FIG. 4A, when device 1 is in a power-on state, display portion 21 may display various information, such as an e-mail message. In an embodiment of the invention, a lower portion, e.g., a footer portion, of display portion 21 also may display information, such as a page number. When device 1 is in a power-on state, then when power key 15 is pressed, or any of operation keys 14 is not pressed for the power-off setting time period, power may be turned off, and device 1 may transition to a power-off state. At this time, display portion 21 may display the set power-off display information, e.g. information 1, and such a message “Power off” at the lower portion of display portion 21, as shown in FIG. 4B.

As shown in FIG. 4B, when device 1 is in a power-off state, then when power key 15, or any of operation keys 14, is pressed, power may be turned on, and device 1 may transition to a power-on state. At this time, information, e.g., the e-mail message shown in FIG. 4A, that was displayed in display portion 21 before power was turned off, may be displayed again in display portion 21. If the device is configured to display a notification display when device 1 is in a power-off state, e.g., the notification display is set as the power-off display information, the information that was displayed in display portion 21 immediately before power is turned off, may not be displayed in display portion 21 when power is turned on. In an embodiment of the invention, in this case, a top, or start page, e.g., the top page shown in FIG. 4E, may appear.

When more than one piece, e.g., a plurality, of power-off display information, e.g., information 1, 2, and 3, is set in the power-off display table for one object, each of the plurality of pieces of power-off display information may be displayed. In an embodiment of the invention, as shown in FIG. 4C, each of the pieces of power-off display information may be set in a line. Moreover, the lower portion of the display area of display portion 21 may display a message, e.g., “Power off.” In other words, CPU 10 may simultaneously display a plurality of pieces of information in display portion 21 when power is turned off. Thus, a plurality of pieces of information may be recognized at a time when power is turned off.

In an embodiment, when a plurality of pieces of power-off display information is set for one object, the pieces of information may be arranged in line in display portion 21. In another embodiment, any one piece of the power-off display information, e.g., information 2, may be selected from a plurality of pieces of set information and may be displayed. In an embodiment of the invention, every time the device 1 power is turned off, CPU 10 may sequentially select and display different pieces of the power-off display information. Thus, different pieces of the power-off display information, which may be sequentially displayed, may hold the interest of a user of device 1. Further, by displaying pieces of power-off display information sequentially, the information may be displayed without reducing its display size.

In an embodiment, CPU 10 may be configured to display in the display device information associated with the information displayed in the display device immediately before power is turned off, among the plurality of pieces of information stored in the information storage portion, in the power-off state. Therefore, information corresponding to the information that a user is viewing, may be displayed. Thus, the information displayed in the power-on state, and information displayed in the power-off state, may be associated.

When the notification display is set as the power-off display information, information that was displayed in display portion 21 immediately before power is turned off, may be erased. As shown in FIG. 4D, textual information, such as “Power off,” may be displayed at a middle portion of the display area in display portion 21 when the device 1 power is off. This mode may function to increase security of information displayed on device 1.

A predetermined operation of one or more of operation keys 14 may cause a screen, such as the screen shown in FIG. 4F, to appear. When such a screen appears, a user of device 1 may set the power-off setting time and the device-based power off display information, using operation keys 14 on the screen shown in FIG. 4F. When the power-off setting time has been set, while device 1 is in a power-on state, when the power-off setting time elapses without an operation of any operation keys 14, power to device 1 may be turned off.

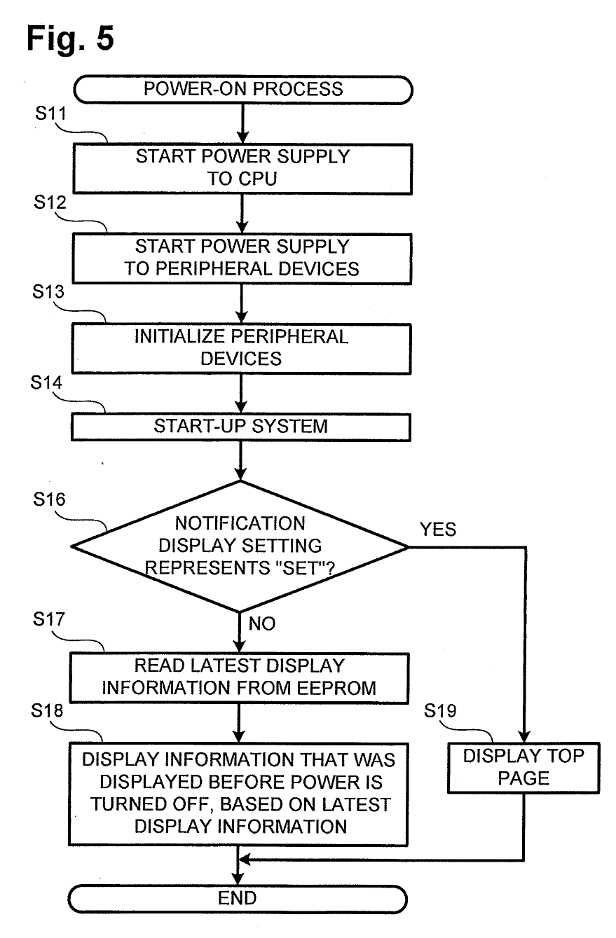

FIG. 5 shows a power-on process which may be performed when device 1 is in a power-off state. In an embodiment of the invention, the power-on process may be performed, e.g., when power key 15 or operation key 14 is pressed. When the power-on process starts, then at Step S11, power supply to CPU 10 may start. Then, at Step S12, power supply to the peripheral devices also may start. Thereafter, at Step S13, the peripheral devices may be initialized. At Step S14, CPU 10 may start up the system.

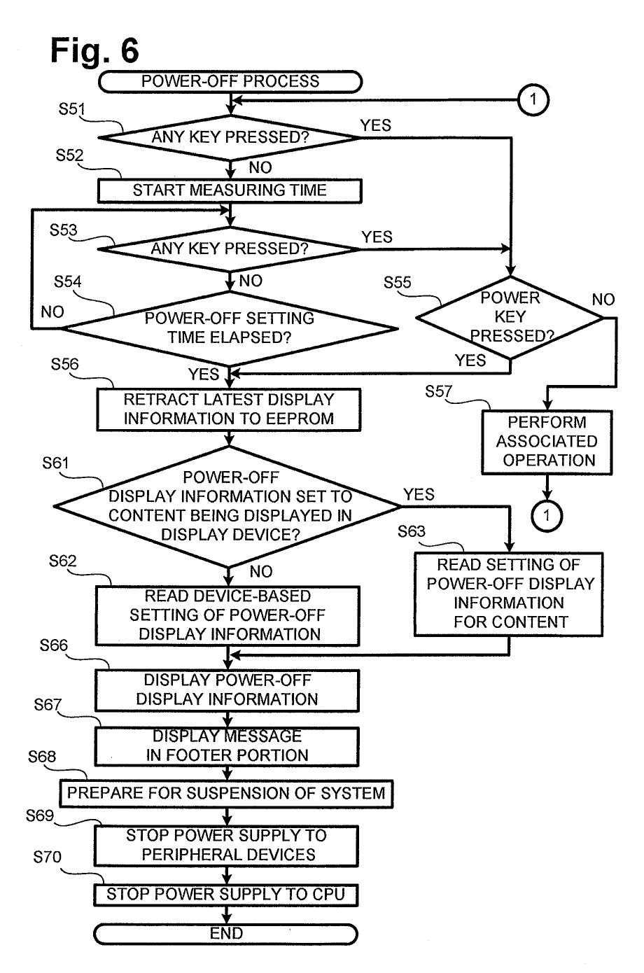

At Step S16, CPU 10 may determine whether a notification display setting in EEPROM 18 represents “set.” In an embodiment of the invention, the notification display setting may represent whether information displayed in display portion 21 when power is turned off is the notification display. The notification display setting may be stored in EEPROM 18 at Step S66 of FIG. 6, as will be discussed in more detail herein. When CPU 10 determines that the notification display setting in EEPROM 18 represents “set”, e.g., “YES” at Step S16, then processing may proceed to Step S19. When CPU 10 determines that the notification display setting in EEPROM 18 represents “not set”, e.g., “NO” at Step S16, then processing may proceed to Step S17.

If “YES” at Step S16, then at Step S17, CPU 10 may read latest display information from EEPROM 18. Latest display information may represent information that was displayed in display portion 21 before power to device 1 is turned off. The latest display information may be stored in EEPROM 18 at Step S56 of FIG. 6, as will be discussed in more detail herein. At Step S18, CPU 10 may display the information that was displayed before power is turned off, based on the latest display information read from EEPROM 18 at Step S17. In these steps, device 1 is transitioning from a power-off state to a power-on state. Thus, CPU 10 may be controlling display portion 21 to display the “Power off” notification, as shown in FIG. 4D. Nevertheless, at Step S16, CPU 10 may control display portion 21 to display the information, e.g., e-mail message shown in FIG. 4A, that was displayed before power is turned off.

If “NO” at Step S17, then at Step S19, CPU 10 may display the top page, e.g., a page not related to contents stored in memory card 23 of device 1. Thus, when the notification display setting represents “set”, CPU 10 may control display portion 21 to display a top page, e.g., the top page shown in FIG. 4E.

FIG. 6 shows a power-off process which may be invoked at a timing when device 1 is in a power-on state and transitions to a power-off state. CPU 10 may determine at Step S51 whether any key is pressed. When CPU 10 determines that any key, e.g., any of operation keys 14, or power key 15, is pressed, e.g., “YES” at Step S51, processing may proceed to Step S55. When CPU 10 determines that a key is not pressed, e.g., “NO” at Step S51, then at Step S52, CPU 10 may start measuring time elapsed since a key has been pressed, using a timer.

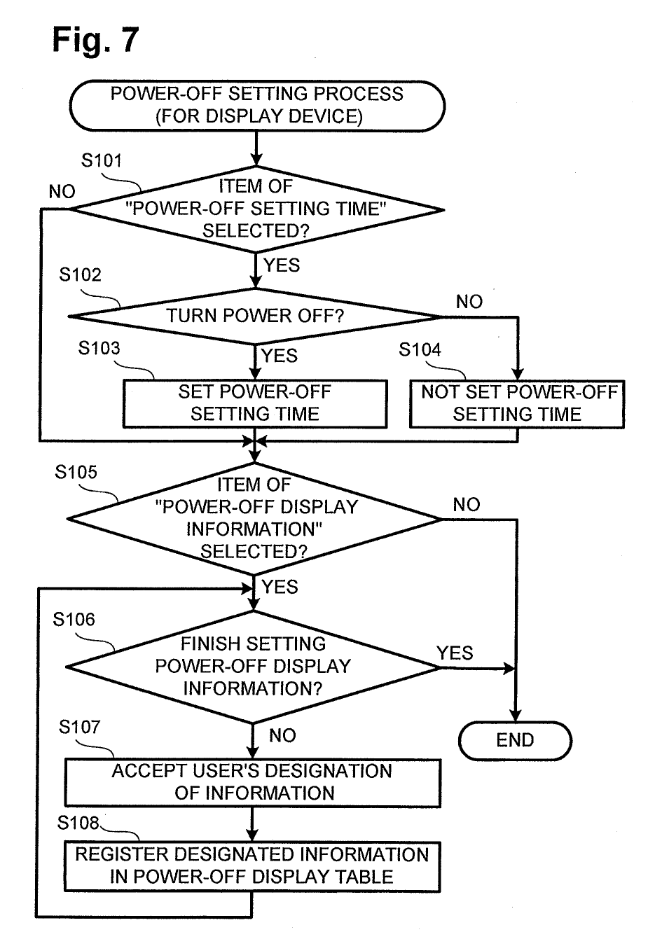

At Step S53, CPU 10 again may determine whether any key is pressed. When CPU 10 determines that any key, e.g., any of operation keys 14 or power key 15 is pressed, e.g., “YES” at Step S53, processing may proceed to Step S55. When CPU 10 determines that a key has not been pressed, e.g., “NO” at Step S53, then processing may proceed to Step S54. At Step S54, CPU 10 may determine in Step S54 whether the power-off setting time has elapsed. The power-off setting time may be stored in EEPROM 18 in Step S103 or Step S104 of FIG. 7, discussed in more detail herein. When CPU 10 determines the power-off setting time has elapsed, e.g., “YES” at Step S54, then processing may proceed to Step S56. When CPU 10 determines the power-off setting time has not elapsed, e.g., “NO” at Step S54, processing may return to Step S53.

If a key is pressed, e.g., “YES” at Steps S51 or S53, then at Step S55, CPU 10 may determine whether the key pressed is power key 15. When CPU 10 determines that the key pressed is power key 15, e.g., “YES” at Step S55, then processing may proceed to Step S56. When CPU 10 determines that the key pressed is not power key 15, e.g., “NO” at Step S55, then processing may proceed to Step S57. At Step S57, CPU 10 may perform an operation associated with the pressed key. After CPU 10 performs the operation, processing may return to Step S51.

When device 1 is in a power-on state, and the power-off setting time elapses without any key operation, e.g., “YES” at Step S56, processing may proceed to Step S56. When power key 15 is pressed in a power-on state, processing also may proceed to Step S56. At Step S56, CPU 10 may retract, e.g., move or copy, latest display information to EEPROM 18. The latest display information may comprise information to identify the content being displayed in display portion 21, and also may comprise the number of pages of the content. Because the latest display information may be stored in EEPROM 18, then even when device 1 is in a power-off state, CPU 10 may recognize, when power is turned on, the information that was displayed in display portion 21 immediately before power is turned off.

When the notification display is not set as the power-off display information, the information that was displayed immediately before power is turned off, may be restored and displayed again in display portion 21, when power is turned on. In another embodiment of the invention, device 1 may be configured such that the information that was displayed immediately before power is turned off may be restored and displayed again when power is turned on, by pressing power key 15 and any of operation keys 14 simultaneously, regardless of whether the notification display is set as the power-off display information. In yet another embodiment of the invention, the information that was displayed immediately before power is turned off may not be restored with any operation, regardless of whether the notification display is set as the power-off display information. In this case, the information that was displayed immediately before power is turned off, may not be restored. In this embodiment, Step S56, in which the latest display information may be retracted to EEPROM 18, may be omitted.

CPU 10 may determine at Step S61 whether the power-off display information is set to the content being displayed in display portion 21. This determination may be based on whether the power-off display table for contents stores the content being displayed in display portion 21 as an object for which power-off display information is set. When CPU 10 determines that the power-off display information is set to the content being displayed in display portion 21, e.g., “YES” at Step S61, then processing may proceed to Step S63. At Step S63, the setting of the power-off display information for the content may be read out from memory card 23. After CPU 10 reads out the setting of the power-off display information for the content from memory card 23, then processing may proceed to Step S66.

When CPU 10 determines that the power-off display information is not set to the content being displayed in display portion 21, e.g., “NO” at Step S61, then processing may proceed to Step S62. At Step S62, the device-based setting of the power-off display information, which may be stored in the power-off display table for the device, may be read from EEPROM 18. Then, processing may proceed to Step S66. In an embodiment of the invention, even when the information displayed at Step S61 in display portion 21 is not a content, processing may proceed to Step S62. For example, while the top page is displayed in display portion 21 at Step S61, processing may proceed to Step S62.

At Step S66, CPU 10 may display the power-off display information, based on the read setting of the power-off display information. At Step S67, the message, “Power off” may be displayed in the lower portion of the display area of display portion 21, e.g., footer portion, in Step S67. Then, processing may proceed to Step S68. When CPU 10 determines, based on the power-off display table, that a plurality of pieces of power-off display information is set to a content, the pieces of power-off display information may be displayed in line in display portion 21. At Step S68, CPU 10 may prepare for the suspension of the system, e.g., CPU 10 may output an instruction to the peripheral devices to stop their operation. Then, at Step S69, the power supply to the peripheral devices may be suspended. At Step S70, the power supply to CPU 10 may be suspended. Thus, power may be turned off, and device 1 may transition from a power-on state to a power-off state.

A setting in the power-off display table for device 1, e.g., the setting referred to in Step S62, may be made with a user's operation, and may be stored in EEPROM 18. CPU 10 may display, in a power-off state, information designated with operations of keys, e.g., with operations of operation keys 14. In this manner, in an embodiment of the invention, a user may designate the information that may be displayed in display portion 21 in a power-off state. Thus, the information that a user desires, may be readily displayed in display portion 21 when power is turned off. In an embodiment of the invention, when a plurality of pieces of information is set for one object as the power-off display information, CPU 10 may display the pieces of information simultaneously in display portion 21 in a power-off state. This may enable a plurality of pieces of information to be recognized at a time.

CPU 10 may display information corresponding to information, e.g., a content, that was displayed immediately before power is turned off, among a plurality of pieces of information stored in memory card 23. Therefore, information corresponding to the information that a user is viewing, may be displayed in display portion 21. The information displayed in the power-on state of device 1, and the information displayed in the power-off state of device 1 may be associated with each other.

Referring to FIG. 7, a power-off setting process may be performed in device 1 to set a power-off setting time and/or power-off display information. When a user performs a predetermined operation when device 1 is in a power-on state, a screen such as the screen shown in FIG. 4F may appear. Thereafter, the power-off setting process may be invoked. The screen may display items which allow a user to set a power-off setting time and power-off display information.

When the power-off setting process is invoked, then at Step S101, CPU 10 may determine whether the operation of operation keys 14 has led to selection of the “power-off setting time” item. When CPU 10 determines that the “power-off setting time” item is selected, e.g., “YES” at Step S101, CPU 10 may display a message to encourage a user to select whether to enable an auto-power off function to automatically turn power off. The user's selection may be selected using operation keys 14. At Step S102, CPU 10 may determine whether the auto-power off function power is enabled, e.g., whether power to device 1 is turned off after lapse of the setting time. This determination may be based on the user's selection. When CPU 10 determines that power to device is turned off after the setting time elapses, e.g., “YES” at Step S102, CPU 10 may display a message to allow a user to input the power-off setting time. At Step S103, CPU 10 may read the value input by the user, and set this value as the power-off setting time. Then, CPU 10 may display a screen, such as the screen shown in FIG. 4F. Then, processing may proceed to Step S105.

When CPU 10 determines that power to the device 1 is not to be turned off after the power-off setting time lapses, e.g., “NO” at Step S102, then at Step S104, CPU 10 may not set the power-off setting time, and may display a screen, e.g., the screen shown in FIG. 4F. Then, processing may proceed to Step S105. Similarly, when CPU 10 determines that the item of “power-off setting time” is not selected, e.g., “NO” at Step S101, processing may proceed to Step S105.

At Step S105, CPU 10 may determine whether operations of operation keys 14 have selected an item of “power-off display information.” When CPU 10 determines that the item of “power-off display information” has been selected, e.g., “YES” at Step S105, then at Step S106, CPU 10 may display a message to allow a user to set the power-off display information, and determine whether an operation to set power-off display information is finished. When CPU 10 determines that the operation to set power-off display information is not finished, e.g., “NO” at Step S106, processing may proceed to Step S107. When CPU 10 determines that an operation to set power-off display information is finished, e.g., “YES” at Step S106, or when the item of “power-off display information” is not selected, e.g., “NO” at Step S105, processing may end.

At Step S107, CPU 10 may accept a user's designation of the information to be displayed in a power-off state. Moreover, at Step S107, information stored in memory card 23 may be designated. At Step S108, CPU 10 may register the information designated by a user in the power-off display table for device. Then, processing may return to Step S106. CPU 10 may store one or more pieces of information, e.g., information 1, information 2, or notification display, designated by a user's operation using operation keys 14. These one or more pieces of information may be stored in the power-off display table for device 1.

FIG. 8 describes a power-off setting process that may be invoked by a predetermined operation in external device 200, according to an embodiment of the invention. The process may be executed after a predetermined operation is performed in external device 200, and a menu screen is displayed in display portion 221. The menu screen may list a plurality of selectable items, one of which may be the “power-off display information.” Referring to FIG. 8, at Step S211, CPU 210 may determine whether operation portion 214 selects a “power-off display information” item When CPU 210 determines that the “power-off display information” is selected, e.g., “YES” at Step S111, CPU 210 may display a list of contents stored in memory card 23 in display portion 221 at Step S112 CPU 210 also may display a message to allow a user to select a content to which the power-off display information may be set. At Step S113, CPU 210 may determine whether the user selected a content. When CPU 210 determines that the user selected a content, e.g., “YES” at Step S113, processing may proceed to Step S114.

When CPU 210 determines that the item of “power-off display information” is not selected, e.g., “NO” at Step S111, or when CPU 210 determines that the user did not select a content, e.g., “NO” at Step S113, processing may proceed to Step S116. At Step S116, CPU 210 may determine whether an other item is selected from the menu. When CPU 210 determines that an other item is selected from the menu, e.g., “YES” at Step S116, then at Step S117, an operation associated with the selected other item may be performed. Then, processing may return to Step S111. When CPU 210 determines that an other item is not selected from the menu, e.g., “NO” at Step S116, processing may end.

At Step S114, CPU 210 may accept a user's designation of information to be displayed in power-off state, e.g., the power-off display information may be set. Further, at Step S114, information stored in memory card 23 or HDD 218 may be designated. At Step S115, CPU 210 may register the information designated by a user as a setting of the power-off display information corresponding to the content selected in Step S112. The designated information may be stored in the power-off display table for contents. In an embodiment of the invention, if memory card 23 does not pre-store data, e.g., image data, of the information registered as the setting of power-off display information in the power-off display table for contents, then at Step S115, CPU 210 may store the data of the information designated by a user in memory card 23. Processing then may return to Step S112.

CPU 210 may store, in the power-off display table for contents, one or more pieces of information, e.g., information 1, information 2, or notification display, selected using operation portion 214, as the information associated with a content displayed in a power-on state, immediately before power is turned off. With operations of operation portion 214, CPU 210 may store the information to be displayed in a power-off state in association with a content, in memory card 23. CPU 10 of device 1 may read memory card 23 and display the information, e.g., information 1, information 2, or notification display, in association with the content being displayed, immediately before power is turned off.

In device 1, a user may designate information that may be displayed in display portion 21 in a power-off state. Thus, information that the user desires may be displayed in display portion 21 in a power-off state, which may be convenient for users.

In an embodiment of the invention, CPU 10 may correspond to a controller. Display portion 21 may correspond to a non-volatile display device. Operation keys 14 may correspond to an operation device. EEPROM 18 and memory card 23 may correspond to an information storage portion.

In the above-described embodiment, the power-off display table for device 1 shown in FIG. 3A may be updated in device 1. The power-off display table for contents shown in FIG. 3B may be updated in external device 200. In another embodiment, the power-off display table for contents may be updated in device 1, and the power-off display table for device may be updated in external device 200.

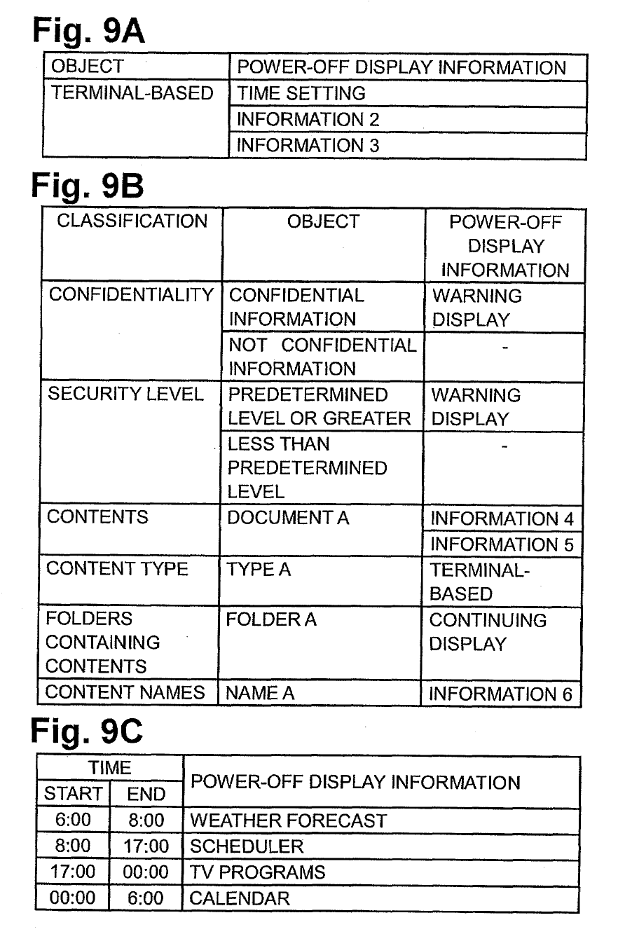

In an embodiment, power-off display information may be set for each content. In another embodiment, power-off display information may be set for each folder containing contents or may be set according to content types, content names, e.g., the first letter of the contents, confidentiality of contents, security levels of contents, or time when power is turned off. FIGS. 9A-9C describe one such embodiment, but are merely intended to be exemplary. Similar structures and process to the above embodiments will be omitted, and differences will be described in detail below with respect to this embodiment.

FIGS. 9A-9C show power-off display tables according to an embodiment of the invention. The tables shown in FIGS. 9A-9C may be referred to in order to determine the information to be displayed in a power-off state, e.g., the power-off display information. The power-off display table may comprise a power-off display table for device 1, as shown in FIG. 9A, a power-off display table for contents, as shown in FIG. 9B, and a power-off display table for time, as shown in FIG. 9C. The power-off display table for device 1 may store settings of power-off display information for device 1. When more than one, e.g., a plurality of, pieces of information is set for one object, as shown in FIG. 9A, the pieces of information may be displayed in display portion 21 by dividing its display area into a plurality of sections, as shown in FIG. 4C. The power-off display table for device 1 may store time settings as a setting of power-off display information. Based on the power-off display table for time, as shown in FIG. 9C, other information, e.g., weather forecast, scheduler, TV programs, or calendar, may be displayed in display area of display portion 21 in a power-off state.

The power-off display table for contents may store settings according to contents, content type, folders containing contents, content names, confidentiality of contents, and security level of contents. The power-off display table for contents may store settings in association with classification, setting objects and power-off display information.

Referring to FIG. 9B, classification may comprise contents, content types, folders containing contents, content names, confidentiality of contents, and security level of contents. The power-off display information may be set for each classification. Contents may be classified according to types, e.g., file formats of contents, categories of contents, e.g., sports, politics, and economics. Contents may also be classified according to content names, e.g., file names starting with a specific letter, e.g., the letter “A” or “B”. Contents may be classified according to confidentiality, e.g., whether a content comprises confidential information. Contents may be classified according to security levels, e.g., security levels preset to contents.

Any classification, e.g., any of the classifications listed above, or similar classifications, may be selected at Step S112 of FIG. 8, instead of a content, and may be associated with the power-off display information. For example, the classification may correspond to an information type. In another embodiment, power-off display information associated with the information displayed in display portion 21 may be the same information type, e.g., classification, as that of the information displayed in display portion 21. Power-off display information may be set according to classification, using the power-off display table for contents shown in FIG. 9B. This configuration may be convenient for users.

A continuing display, e.g., a display which continues to display the image that was on the screen in the power-on state, after the device is in a power-off state, may be set in the power-off display table for contents, as power-off display information. With the setting of the continuing display, the information displayed in a power-on state may be continuously displayed in a power-off state. The continuing display may be designated in Step S107 of FIG. 7 or Step S114 of FIG. 8, and may be associated as the power-off display information.

When the power-off display information includes images, or the notification display, CPU 10 may display the images or notification display in display portion 21, when device 1 is in a power-off state. When the power-off display information is the continuing display, CPU 10 may continuously display the information displayed in a power-on state, even in a power-off state. For example, if a content being displayed in display portion 21 in a power-on state is contained in folder A, the content displayed in a power-on state may be continuously displayed in display portion 21 in a power-off state, based on the setting in the power-off display table for contents, shown in FIG. 9B.

In another embodiment, power-off display information associated with the information displayed in display portion 21 may be stored in a folder storing in the information displayed in display portion 21.

A warning display may be set in the power-off display table for contents as power-off display information. With the warning display, when power is turned off, information displayed in a power-on state may be erased and such a warning message may be displayed in display portion 21, that may inform a user that power is turned off while confidential information is being displayed. The warning display may be set for contents which are set as having confidential information, and for contents whose security level is a predetermined level or greater. Therefore, when the security level of a content being displayed in display portion 21 is set to a predetermined level or greater, or when a content being displayed in display portion 21 is set as having confidential information, a warning message may be displayed in display portion 21 when power is turned off. Thus, security of information in device 1 may be increased.

The power-off display table for time, as shown in FIG. 9C, may be applied according to a time of day at which device 1 enters a power-off state. The power-off display table for time may store settings of the power-off display information, in association with a time of day. The time stored in the power-of display table for time may comprise a start time and end time.

For example, as shown in FIG. 9C, for the time between 6:00 a.m. and 8:00 a.m., a weather forecast may be set as the power-off display information. For the time between 8:00 a.m. to 17:00 (5:00 p.m.), a scheduler may be set as the power-off display information. For the time between 17:00 (5:00 p.m.) to 00:00 (midnight), a listing of TV programs may be set as the power-off display information. For the time between midnight to 6:00 a.m., a calendar may be set as the power-off display information. When the power-off display table for device 1 stores a time setting as a setting of power-off display information, CPU 10 may refer to the power-off display table for time.

When power is turned off, CPU 10 may determine, at Step S62 of FIG. 6, power-off display information associated with the time in which power is turned off. Then, at Step S66 of FIG. 6, CPU 10 may display the information accordingly. For example, when power is turned off between 6:00 a.m. and 8:00 a.m., weather forecast may be displayed in a portion of the display area of display portion 21 where information 1 is displayed, as shown in FIG. 4C, together with information 2 and information 3. When power is turned off between 17:00 (5:00 p.m.) and 00:00 (midnight), a schedule TV programs may be displayed in a portion of the display area of display portion 21 where information 1 is displayed in FIG. 4C, together with information 2 and information 3. Thus, information corresponding to the time when power is turned off may be displayed in display portion 21, among a plurality of pieces of information, e.g., weather forecast, and scheduler.

In the above embodiments, EEPROM 18 or memory card 23 may store contents or information about settings of the power-off display table. In another embodiment, EEPROM 18 or memory card 23 may store contents that may be supplied from another device, e.g., via a communication network, or information about settings of the power-off display table. Further, contents or information about settings of the power-off display table may be stored in EEPROM 18 of device 1, via a USB cable or other similar connection. While the invention has been described in connection with various exemplary structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. A portable display device configured to transition between a first state and a second state, the portable display device comprising:
a display portion configured to display information when the portable display device is in the first state and when the portable display device is in the second state;
a power source configured to supply power when the portable display device is in the first state, and to supply less power when the portable display device is in the second state than when the portable display device is in the first state;
a controller configured to drive the display portion to display information in the display portion;
an operation device configured to execute at least one command in response to receipt of at least one operation; and
a storage portion configured to store information to be displayed in the display portion when the portable display device is in the second state,
wherein the controller is configured to display, in the display portion, the information stored in the storage portion, when the portable display device is in the second state.

2. The portable display device of claim 1, wherein the storage portion is configured to store one or more pieces of information, and wherein the one or more pieces of information are designated by the operation of the operation device.

3. The portable display device of claim 2, wherein the one or more pieces of information comprises a plurality of pieces of information, and wherein the controller is configured to display, in the display portion, each of the plurality of pieces of information at the same time, when the portable display device is in the second state.

4. The portable display device of claim 2, wherein the one or more pieces of information comprises a plurality of pieces of information, and wherein the controller is configured to sequentially select each one of the pieces of information from the plurality of pieces of information stored in the information storage portion, and to sequentially display the selected pieces of information in the display portion, when the portable display device is in the second state.

5. The portable display device of claim 2, wherein the one or more pieces of information comprises a plurality of pieces of information, the controller is configured to display a latest information in the display portion, and the latest information is associated with the information displayed in the display portion when the portable display device transitions from the first state to the second state, and
wherein the controller is configured to display the latest information among a displaying of the plurality of pieces of information stored in the information storage portion, when the portable display device is in the second state.

6. The portable display device of claim 5, wherein the latest information is stored in a folder configured to store information displayed in the display portion when the portable display device is in the first state.

7. The portable display device of claim 5, wherein the latest information is stored in a folder configured to store information of a same information type as that of the information displayed in the display portion.

8. The portable display device of claim 2, wherein the one or more pieces of information comprises a plurality of pieces of information, wherein the controller is configured to display time information corresponding to an actual time when the portable display device transitions from the first state to the second state, and wherein the controller is configured to display the time information among a displaying of the plurality of pieces of information stored in the information storage portion, when the portable display device is in the second state.

9. The portable display device of claim 1, further comprising:
a mode storage portion configured to store one of a first mode and a second mode, wherein the first mode comprises a setting corresponding to preset information displayed in the display portion, and the second mode comprises a setting corresponding to information displayed in the display portion to be continuously displayed in the display device,
wherein the mode storage portion stores one of the first mode and the second mode based on the operation of the operation device, and
wherein when the portable display device is in the second state, the controller is configured to display the preset information displayed in the display portion, when the first mode is stored in the mode storage portion, and to continuously display the information displayed in the display portion, when the second mode is stored in the mode storage portion.

10. The portable display device of claim 1, wherein the display portion is a non-volatile display portion.

11. A computer program product having computer readable instructions stored thereon, which, when executed by a processor of a portable display device, configures the processor to perform the steps of:
driving a display portion to display information when the portable display device is in a first state, the first state corresponding to the portable display device receiving a power supply from a power source;
receiving at least one operation command from at least one operation device;
storing information in an information storage portion, to be displayed in the display portion when the portable display device is in a second state, the second state corresponding to the portable display device receiving less power from the power source than when the portable display device is in the first state;
transitioning the portable display device from the first state to the second state; and
displaying the information stored in the information storage portion, when the portable display device is in the second state.
